(19) United States
(12) Patent Application Publication
(10) Pub. No.: US 2025/0300297 A1
(43) Pub. Date: Sep. 25, 2025

(54) BATTERY CASE

(71) Applicant: Isuzu Motors Limited, Yokohama-shi (JP)

(72) Inventor: Kazuhiro TATEISHI, Fujisawa-shi (JP)

(73) Assignee: Isuzu Motors Limited, Yokohama-shi (JP)

(21) Appl. No.: 19/058,079

(22) Filed: Feb. 20, 2025

(30) Foreign Application Priority Data
Mar. 22, 2024 (JP) 2024-046668

(51) Int. Cl. H01M 50/262; H01M 50/213; H01M 50/244; H01M 50/503; H01M 50/505; H01M 50/516

(52) U.S. Cl. CPC H01M 50/262; H01M 50/213; H01M 50/244; H01M 50/503; H01M 50/505; H01M 50/516

(57) ABSTRACT

A battery case includes: a first frame in which a plurality of first housing holes each capable of housing one end portion of a battery cell are formed, the battery cell having connection terminals at the one end portion; and a second frame in which a plurality of second housing holes each capable of housing the other end portion of the battery cell are formed, the second frame forming a housing chamber, using the first housing hole and the second housing hole, the housing chamber being capable of housing the battery cell, in which the first housing hole includes a fixing portion that positions and fixes the one end portion of the battery cell.

### CROSS REFERENCE TO RELATED APPLICATIONS

This application claims the benefit of priority of Japanese Patent Application No. 2024-046668, filed on Mar. 22, 2024, the contents of which are incorporated by reference as if fully set forth herein in their entirety.

### TECHNICAL FIELD

The present disclosure relates to a battery case.

### BACKGROUND ART

A battery module that houses a large number of battery cells in a battery case and connects a conductive member to the connection terminals of the battery cells has been known. The Patent Literature (hereinafter referred to as “PTL”) describes a battery module in which a plurality of cylindrical battery cells are arranged side by side.

### CITATION LIST

### Patent Literature

### PTL

Japanese Unexamined Patent Application Publication (Translation of PCT Application) No. 2021-501457

### SUMMARY OF INVENTION

### Technical Problem

In a case where a plurality of battery cells are arranged side by side, there may be variation in the heights of the battery cells. The variation in the heights of the battery cells causes a problem in that the connection quality is not stable when the cells and the electrodes are connected to each other.

An object of the present disclosure is to provide a battery case capable of performing efficiently the bonding operation between connection terminals and a conductive member without reducing the bonding quality, by facilitating the positioning of a battery cell in a height direction.

### Solution to Problem

A battery case of the present disclosure includes: a first frame in which a plurality of first housing holes each capable of housing one end portion of a battery cell are formed, the battery cell having connection terminals at the one end portion; and a second frame in which a plurality of second housing holes each capable of housing the other end portion of the battery cell are formed, the second frame forming a housing chamber, using the first housing hole and the second housing hole, the housing chamber being capable of housing the battery cell, in which the first housing hole includes a fixing portion that positions and fixes the one end portion of the battery cell.

### Advantageous Effects of Invention

In the present disclosure, an end portion of each battery cell on a side with connection terminals is positioned and fixed in a first housing hole of a first frame in order to align the height of the connection terminals of the battery cell with respect to the first frame, thereby improving the efficiency in an operation of connecting a conductive member to the connection terminals and improving the quality of a connection portion.

### BRIEF DESCRIPTION OF DRAWINGS

FIG. 1 illustrates an appearance of a battery module;

FIG. 2 is an exploded view of the battery module;

FIG. 3 is a further exploded view of the battery module;

FIG. 4A is a cross-sectional view of the battery module;

FIG. 4B is an enlarged cross-sectional view of the battery module;

FIG. 5 illustrates an assembly process of the battery module;

FIG. 6 illustrates another assembly process of the battery module;

FIG. 7 is an exploded view of a conventional battery module;

FIG. 8A illustrates an appearance of the conventional battery module; and

FIG. 8B is a partial enlarged view of the conventional battery module.

### DESCRIPTION OF EMBODIMENTS

Hereinafter, an embodiment of the present disclosure will be described with reference to the accompanying drawings. The embodiment described below indicates a specific example of the present disclosure. Therefore, each component, the arrangement position and the connection form of each component, and the like illustrated in the following embodiment are examples and are not intended to limit the present disclosure. In addition, components that are not described in the independent claims among components in the following embodiment are described as optional components.

Each drawing is a schematic diagram and is not necessarily a strict illustration. In each drawing, the substantially same configuration are given the same reference numerals, and redundant explanations are omitted or simplified.

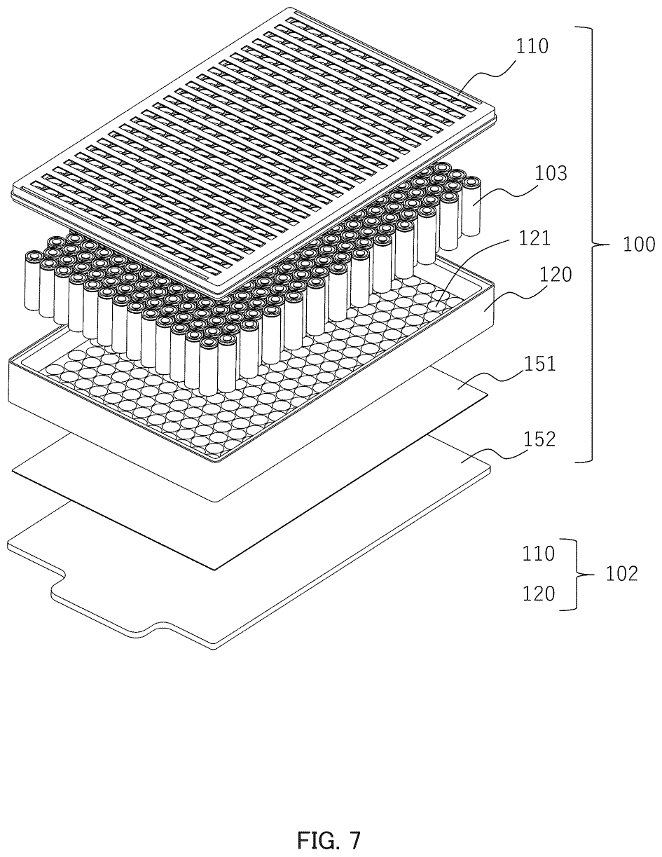

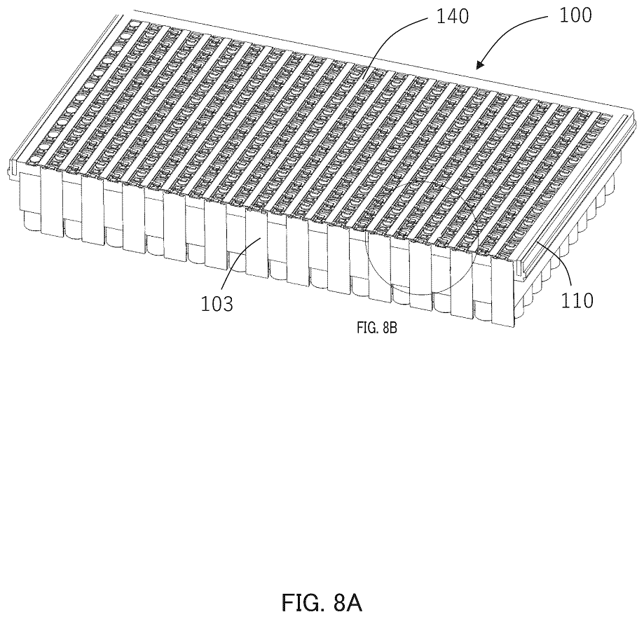

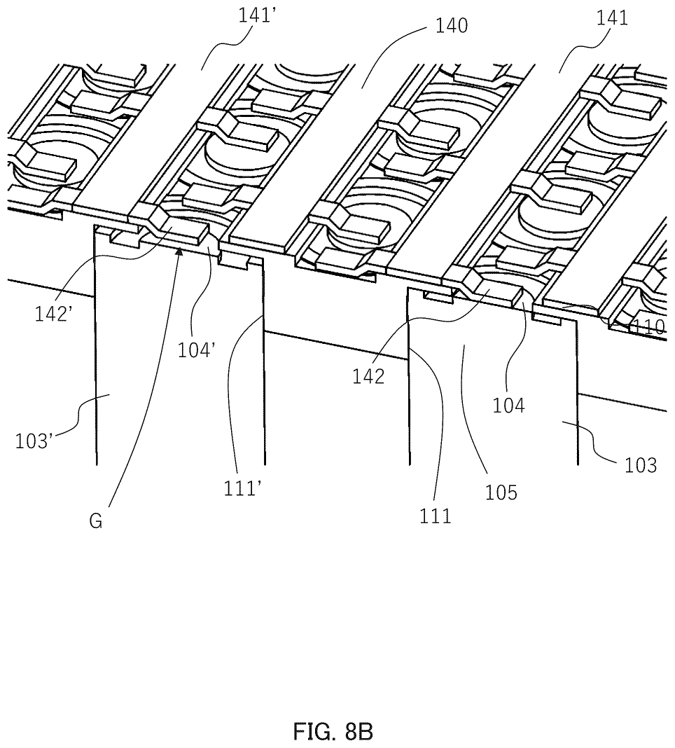

First, battery module 100 of a comparative example will be described. A battery module that houses a large number of battery cells in a battery case and connects a conductive member to the connection terminals of the battery cells has been known. FIG. 7 is an exploded view of a main part of conventional battery module 100. FIG. 8A illustrates an appearance of battery module 100, and FIG. 8B is a partial enlarged view thereof. Note that some members are omitted from the drawings.

Battery cell 103 is housed in battery case 102 including first frame 110 and second frame 120. First frame 110 and second frame 120 are each formed with a large number of first housing holes 111 and second housing holes 121 facing correspondingly each other, and a housing chamber for battery cell 103 is formed by first housing hole 111 and second housing hole 121.

Upper portion 105 of battery cell 103 is housed in first housing hole 111, and a lower portion of battery cell 103 is housed in second housing hole 121, thereby fixing and housing battery cell 103 in battery case 102.

Bus bar 140 as a conductive member is provided on an upper surface of first frame 110, and connection piece 142 formed to protrude laterally from main body portion 141 is overlaid on connection terminals 104 of battery cell 103 and is bonded by laser welding or the like. Note that, in the illustrated example, bus bar 140 and connection terminals 104 are bonded by connection piece 142, but main body portion 141 of bus bar 140 and connection terminals 104 may be connected by wire bonding.

For assembling battery module 100, second frame 120 is mounted on a mounting table such that second housing hole 121 is oriented upward, battery cell 103 is housed in second housing hole 121 such that connection terminals 104 faces upward, and thus, first frame 110 is placed on and coupled to second frame 120 such that first housing hole 111 faces downward and upper portion 105 of battery cell 103 is housed in first housing hole 111.

Next, bus bar 140 is attached onto first frame 110, and connection piece 142 is bonded to connection terminals 104. Then, a potting agent (not illustrated) is applied in order to coat bus bar 140, over which a top cover (not illustrated) is placed. Further, cooling plate 152 is bonded to a bottom portion of second frame 120 with adhesive 151.

Since bus bar 140 is formed from a plate-shaped member by press molding or the like, the heights of the large number of connection pieces 142 are substantially the same. When connection pieces 142 are bonded to connection terminals 104, a gap may be formed between some connection pieces 142 and connection terminals 104 unless the heights of connection terminals 104 of the plurality of battery cells 103 are not aligned.

In FIG. 8B, battery cell 103 located on a right side has an appropriate height and is inserted to the deepest part (the uppermost part in the drawing) of first housing hole 111, so that connection piece 142 and connection terminals 104 are in appropriate contact with each other, whereas battery cell 103′ located on a left side is at a lower position than battery cell 103 on the right side, and thus is not inserted to the deepest part of first housing hole 111′; hence, gap G is formed between connection piece 142′ and connection terminals 104′.

In order to bond connection piece 142′ and connection terminals 104′ to each other, the processing becomes complicated, such as bonding while lifting battery cell 103′ or bonding while pressing down connection piece 142′, resulting in a decrease in the efficiency in the bonding operation. Additionally, even when the bonding is successful, there is a problem in that the bonding quality is reduced due to an internal stress remaining in connection piece 142′.

Battery module 1 according to the present disclosure makes it possible to provide a battery case capable of performing efficiently the bonding operation between connection terminals and a conductive member without reducing the bonding quality, by facilitating the positioning of a battery cell in a height direction.

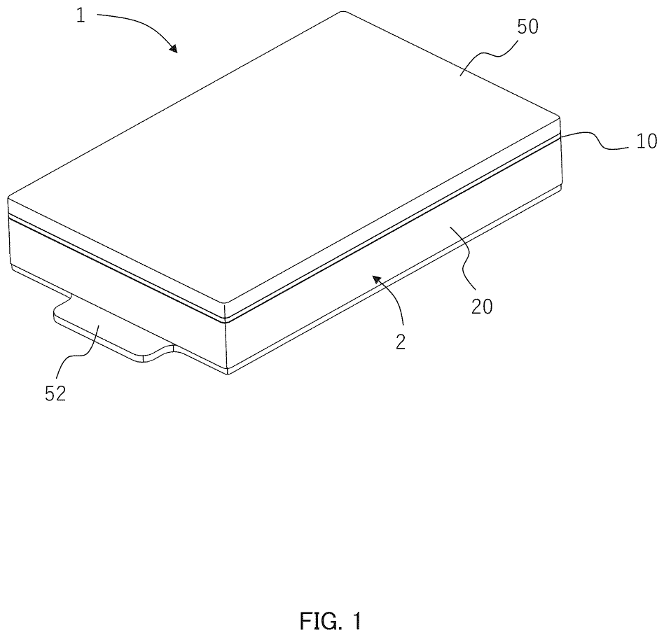

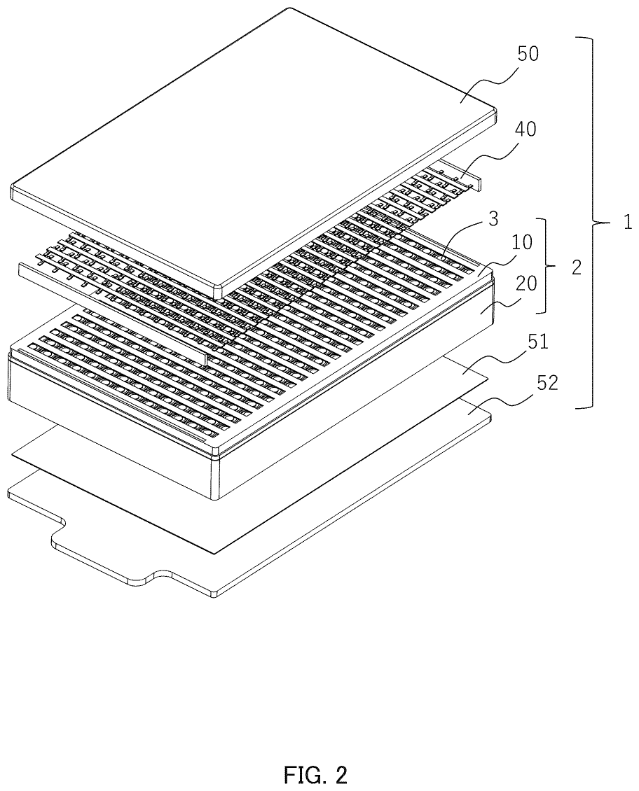

FIG. 1 illustrates an appearance of battery module 1 of the present disclosure, and FIG. 2 is an exploded view of battery module 1. Battery module 1 houses a large number of battery cells 3 in battery case 2 made of resin. Battery case 2 includes first frame 10 and second frame 20, and first frame 10 and second frame 20 form therein housing chambers for battery cells 3. Bus bar 40 is attached onto an upper surface of first frame 10 and is connected to connection terminals of battery cells 3. Bus bar 40 is coated with a potting agent (not illustrated), and further, top cover 50 is provided thereon to cover upper surfaces of first frame 10 and bus bar 40. Further, cooling plate 52 is bonded to a lower surface of second frame 20 with adhesive 51. Lower surfaces of battery cells 3 are exposed from a lower portion of second frame 20 and are connected to cooling plate 52 via adhesive 51.

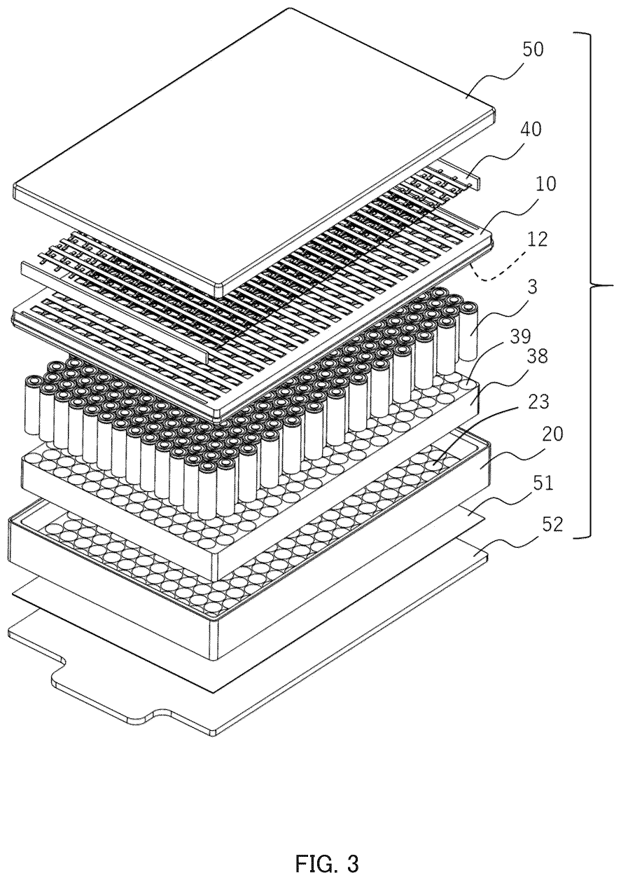

FIG. 3 is a further exploded view of battery case 2 of battery module 1. Second frame 20 is a container-shaped member with an open top, in which a large number of second housing holes 23 for housing the lower portions of battery cells 3 are formed. Second frame 20 houses therein heat insulating material 38 in which a large number of through-holes 39 into which battery cells 3 are inserted are formed. Battery cells 3 are inserted into through-holes 39 such that the lower portions thereof are housed in second housing holes 23 and intermediate portions thereof are surrounded by heat insulating material 38.

First housing holes 12 that house the upper portions of battery cells 3 are formed in first frame 10 and are assembled to second frame 20 to configure battery case 2. Battery cells 3 are housed in first housing holes 12, through-holes 39, and second housing holes 23.

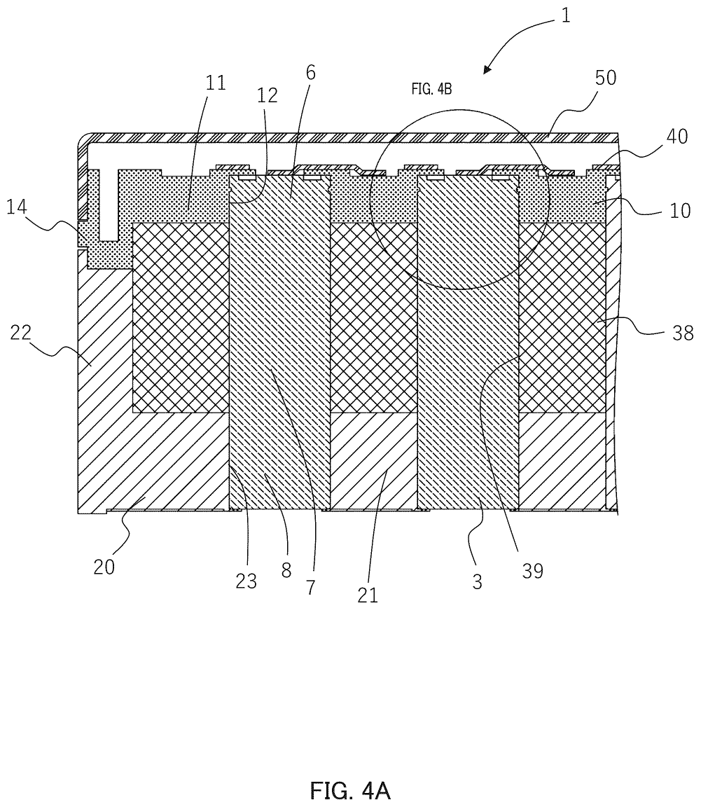

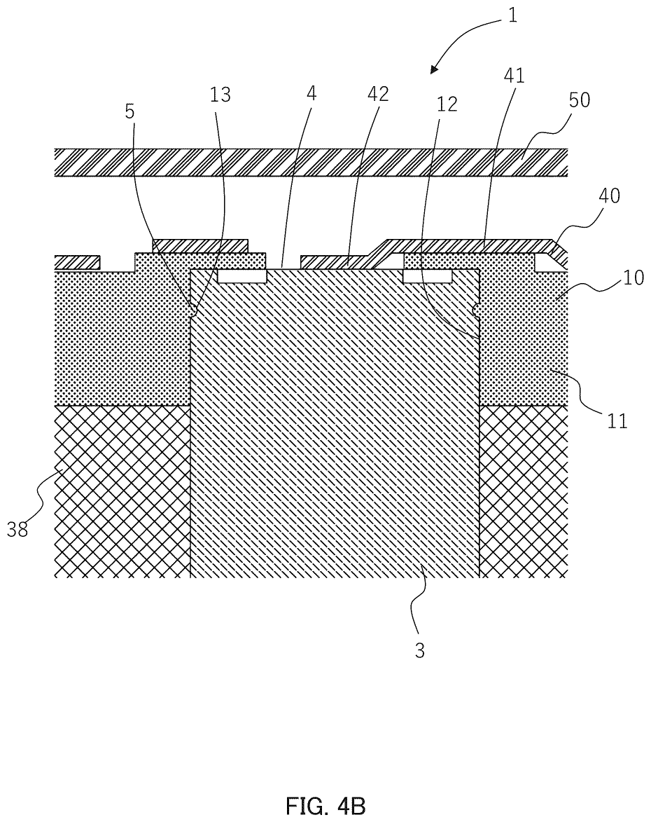

FIG. 4A is a cross-sectional view of battery module 1 in which battery cells 3 of the present disclosure are housed, and FIG. 4B is an enlarged view of a main part thereof. Battery module 1 includes first frame 10 in which a large number of first housing holes 12 are formed, and second frame 20 in which second housing holes 23 respectively corresponding to first housing holes 12 and forming housing chambers together with first housing holes 12 are formed. First housing holes 12 of first frame 10 and second housing holes 23 of second frame 20 form the housing chambers in which battery cells 3 are housed.

First frame 10 is a plate-shaped member, and a large number of first housing holes 12 are formed in main body portion 11 thereof. First frame 10 functions as a lid-shaped member with respect to container-shaped second frame 20. Engagement protrusion portions 13 that protrude inward are formed on the inner surface of each first housing hole 12. Engagement recess portions 5 are formed on the upper side-surface of each battery cell 3, and engagement protrusion portions 13 and engagement recess portions 5 engage with each other, thereby positioning and fixing battery cell 3 with respect to first frame 10.

A large number of second housing holes 23 are formed in main body portion 21 of second frame 20 at positions respectively corresponding to first housing holes 12. Lower portions 8 of battery cells 3 are supported on a lower surface portion of second frame 20.

Peripheral portions of first frame 10 and second frame 20 are peripheral wall portions 14 and 22, respectively, that are fitted to each other and bonded integrally, thus presenting, as a whole, a case-like shape with a space inside.

Between first frame 10 and second frame 20, heat insulating material 38 is housed to cover battery cells 3. Heat insulating material 38 is a thick plate-shaped member made of rigid polyurethane, in which a large number of through-holes 39 into which battery cells 3 are inserted are formed. Note that the material of heat insulating material 38 is not limited to rigid polyurethane.

For each battery cell 3, upper portion 6 is housed in first housing hole 12 of first frame 10 in a fixed manner, intermediate portion 7 is inserted into through-hole 39 of heat insulating material 38, and lower portion 8 is housed in second housing hole 23 of second frame 20.

In FIG. 4B, bus bar 40 as a conductive member is attached to an upper-surface portion of first frame 10. Bus bar 40 includes main body portion 41, which is thin plate-shaped, and connection piece 42, which is plate-shaped and extends in a lateral direction from main body portion 41. Main body portion 41 is attached to the upper surface of first frame 10, and connection piece 42 extends to an upper-surface portion of connection terminals 4 of battery cell 3.

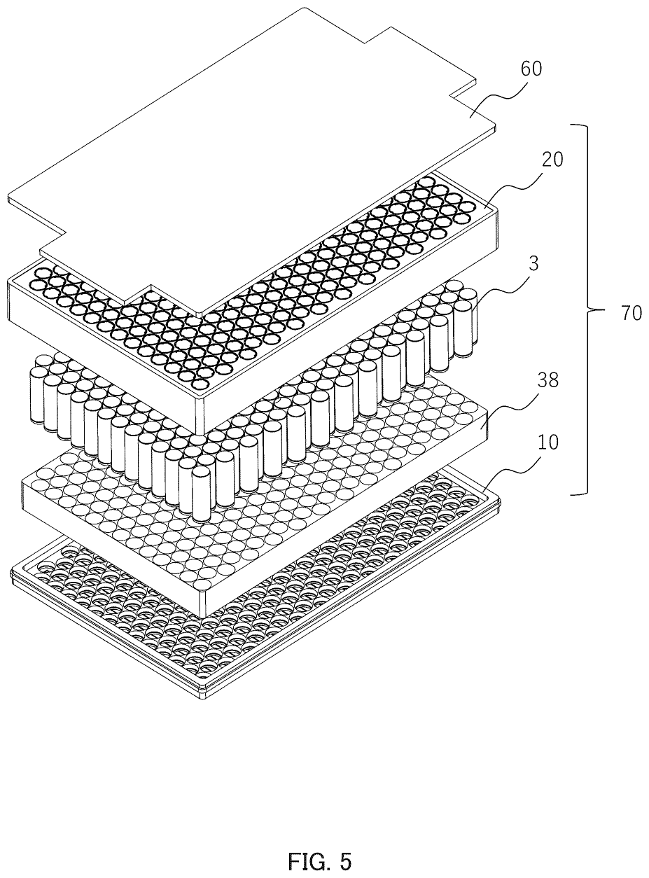

FIG. 5 illustrates a procedure for assembling first assembly 70 in the middle of assembling the battery module. First, first frame 10 is mounted on a mounting surface at a work site where the assembling is performed, such that first housing holes 12 face upward. That is, first frame 10 is mounted on the mounting surface upside down relative to a state in which battery module 1 is normally used.

Next, heat insulating material 38 is turned upside down and positioned such that through-holes 39 are on first housing holes 12, and is mounted on first frame 10.

Next, battery cells 3 are housed in first housing holes 12 by being inserted, with upper portions 6, in which connection terminals 4 are provided, facing downward into through-holes 39 of heat insulating material 38. At this time, engagement protrusion portions 13 provided in first housing holes 12 engage with engagement recess portions 5 provided in battery cells 3, thereby fixing battery cells 3 to first frame 10.

Once all battery cells 3 have been housed and fixed in first housing holes 12, second frame 20 is overlaid on first frame 10 such that second housing holes 23 face downward and house lower portions 8 (upper portions in the drawing) of battery cells 3 in second housing holes 23. First frame 10 and second frame 20 are fixed and integrated to form first assembly 70.

Next, first assembly 70 is inverted such that first frame 10 faces upward and second frame 20 faces downward. At this time, jig 60, which is plate-shaped, is brought into contact with second frame 20 to prevent battery cells 3 from falling out of second housing holes 23 of second frame 20. Note that, in a case where second frame 20 is provided with a positioning portion that prevents battery cells 3 from falling out, the use of jig 60 can be omitted.

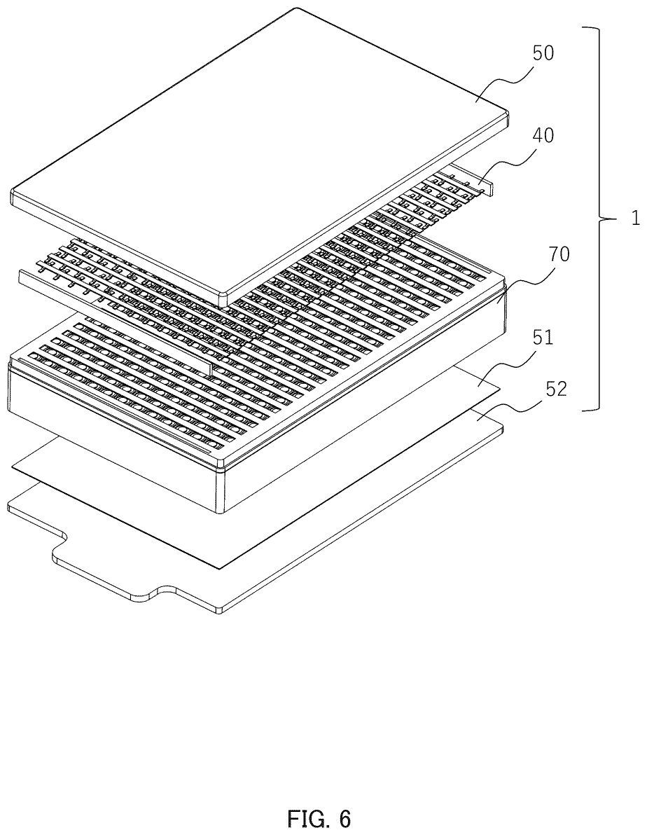

FIG. 6 illustrates a procedure for assembling battery module 1 from inverted first assembly 70. Bus bar 40 is placed on an upper surface of first assembly 70, that is, the upper surface of first frame 10, such that connection pieces 42 of the bus bar are located on predetermined connection terminals 4 of battery cell 3, and connection pieces 42 and connection terminals 4 are fixed by welding. Various publicly known methods can be utilized as a welding method. In the present disclosure, connection pieces 42 and connection terminals 4 are fixed by laser welding. Note that the welding method may be ultrasonic welding or the like.

Then, a potting agent (not illustrated) is applied onto first frame 10 to seal bus bar 40. Then, top cover 50 is placed thereon. Finally, adhesive 51 is applied onto cooling plate 52 for cooling battery cells 3, and first assembly 70 is mounted thereon and thus integrated.

As described above, in a state where first housing holes 12 of first frame 10 face upward, battery cells 3 are housed and fixed by being inserted, with upper portions 6, in which connection terminals 4 are provided, facing downward, into first housing holes 12, so that the positions of connection terminals 4 in a height direction with respect to first frame 10 are aligned. Accordingly, connection pieces 42 of bus bar 40 and connection terminals 4 of battery cells 3 are in appropriate contact with each other, and thus, connection pieces 42 and connection terminals 4 can be efficiently connected by welding.

In the above example, engagement recess portions 5 formed in upper portion 6 of each battery cell 3 and engagement protrusion portions 13 formed in each first housing hole 12 engage with each other to position and fix battery cell 3 to first frame 10, but upper portion 6 of battery cell 3 may be fixed to first housing hole 12 by tight fitting. Further, in addition to the tight fitting, upper portion 6 may be fixed to first housing hole 12 by adhesion. That is, the means for fixing upper portion 6 to first housing hole 12 is not limited as long as upper portion 6 can be appropriately positioned with respect to first housing hole 12.

### INDUSTRIAL APPLICABILITY

The present disclosure can be suitably used for a battery module.

### REFERENCE SIGNS LIST

1 Battery module
2 Battery case
3 Battery cell
10 First frame
20 Second frame
40 Bus bar (conductive member)
50 Top cover
60 Jig
70 First assembly

1. A battery case, comprising:
a first frame in which a plurality of first housing holes each capable of housing one end portion of a battery cell are formed, the battery cell having connection terminals at the one end portion; and
a second frame in which a plurality of second housing holes each capable of housing the other end portion of the battery cell are formed, the second frame forming a housing chamber, using the first housing hole and the second housing hole, the housing chamber being capable of housing the battery cell,
wherein the first housing hole includes a fixing portion that positions and fixes the one end portion of the battery cell.

2. The battery case according to claim 1, wherein the fixing portion is an engagement protrusion portion that engages with an engagement recess portion formed in the battery cell.

3. The battery case according to claim 1, wherein the fixing portion is a reduced-diameter portion into which the battery cell is tightly fitted.

4. The battery case according to claim 1, wherein the fixing portion is an adhesive portion that adheres the battery cell.

5. The battery case according to claim 1, wherein the second housing hole includes a positioning portion that positions the other end portion of the battery cell in a housing direction.

6. A battery module, comprising:
the battery case according to claim 1;
a plurality of battery cells, one end portion of each of which is housed in the first housing hole and is positioned and fixed by the fixing portion, and the other end portion of each of the plurality of battery cells is housed in the second housing hole, the one end portion including connection terminals; and
a conductive member that is attached to an outer surface of the first frame and is connected to the connection terminals of each of the plurality of battery cells.

7. The battery module according to claim 6, wherein:
the conductive member is a plate-shaped bus bar, and
the bus bar and the connection terminals are connected to each other by laser welding.

8. An assembly method for the battery module according to claim 6, comprising:
mounting the first frame on a mounting surface with the first housing hole facing upward;
housing, in the first housing hole, the battery cell with the connection terminals facing downward, and positioning and fixing the battery cell in the first housing hole by the fixing portion;
forming a first assembly in which the battery cell is housed in the housing chamber by overlaying, on the first frame, the second frame with the second housing hole facing downward;
inverting the first assembly upside down; and
attaching a conductive member to an upper surface of the first frame, and connecting the conductive member and the connection terminals.

9. The assembling method for the battery module according to claim 8, wherein:
the conductive member is a plate-shaped bus bar, and
the bus bar and the connection terminals are connected to each other by laser welding.
